(19) United States
(12) Patent Application Publication
(10) Pub. No.: US 2015/0317950 A1
(43) Pub. Date: Nov. 5, 2015

(54) ELECTROPHORETIC DISPLAY APPARATUS AND DRIVE METHOD THEREOF

(71) Applicant: MITSUBISHI PENCIL COMPANY, LIMITED, Tokyo (JP)

(72) Inventors: Masashi Sakagami, Fujioka-shi (JP); Kiyoshi Fujisawa, Fujioka-shi (JP)

(73) Assignee: MITSUBISHI PENCIL CO., LTD., Tokyo (JP)

(21) Appl. No.: 14/439,531

(22) PCT Filed: Oct. 24, 2013
(86) PCT No.: PCT/JP2013/078768

§ 371 Date: Apr. 29, 2015

(30) Foreign Application Priority Data
Oct. 30, 2012 (JP) 2012-238958

(51) Int. Cl. G09G 5/18; G09G 3/34

(52) U.S. Cl. CPC G09G 5/18; G09G 3/344; G09G 2300/0426

(57) ABSTRACT

It is an object of the present invention to make full use of energy stored in storage capacitors connected in parallel to display pixels and prevent variations of display performance and easily adjust the display without replacing the storage capacitors. Storage capacitors 25 that can store charge to continuously move electrophoretic particles in a direction corresponding to a drive voltage for a time longer than a reference frame period even after a drive voltage is turned off by one selection are provided in parallel to respective display pixels (20), pause periods are provided in scan line units or in group units made up of a plurality of continuous scan lines and pause periods are provided so that a scanning interval of each scan line unit is shorter than a time within which the storage capacitors (25) can move electrophoretic particles even after the drive voltage is turned off.

### TECHNICAL FIELD

The present invention relates to an electrophoretic display apparatus that reversibly changes visibility under the action of an electric field or the like and a drive method thereof.

### BACKGROUND ART

Electrophoretic display apparatuses that form images using electrophoretic particles (ink) are known as display apparatuses suitable for electronic paper. In a common electrophoretic display apparatus, display pixels are arranged in a matrix form, a liquid in which electrophoretic particles are dispersed (electrophoretic liquid) is sealed into each display pixel and a pair of electrodes are provided. A pixel signal is supplied from a data line drive circuit to one electrode (pixel electrode) of each display pixel via a data line. Furthermore, a scanning signal is supplied from a scan line drive circuit to each display pixel (pixel electrode) via a scan line so that a pixel signal (drive voltage) is applied to electrophoretic particles of each display pixel. The scanning signal is a pulse signal having a fixed pulse width and each scan line is selected for a period corresponding to the pulse width. A potential difference between each pixel electrode and a common electrode is applied to each display pixel as a drive voltage only for a duration of time that the scan line is selected.

Conventionally, in order to prevent deterioration of image quality due to a decrease in retained charge in display pixels, there is a proposal of a configuration in which a storage capacitor is connected in parallel to a display pixel to retain a voltage applied to electrophoretic particles for each pixel (e.g., see Patent Literature 1). The charge stored in the electrophoretic particles and storage capacitor by one scan is discharged through electrical resistance of the electrophoretic particles themselves until the charge is selected at the next scan. Increasing the capacity of the storage capacitor is believed to increase energy given to the electrophoretic particles and thereby improve display performance.

### CITATION LIST

### Patent Literature

Patent Literature 1

Japanese Patent Application Laid-Open No. 2006-251093

### SUMMARY OF THE INVENTION

### Technical Problem

However, even when the capacity of the storage capacitor is increased and energy given to electrophoretic particles is increased, there may be a possibility that the given energy may not be effectively used. For example, when the number of scan lines is small, the period after one scan line is selected until it is selected next time (scan interval) becomes shorter. For this reason, although the energy given at the first selection is enough to move electrophoretic particles in a drive voltage direction, the next selection (drive) is performed.

The present invention has been implemented in view of the above-described problem, and it is an object of the present invention to provide an electrophoretic display apparatus and a drive method thereof capable of making full use of energy stored in a storage capacitor connected in parallel to a display pixel, preventing variations of display performance and easily adjusting the display without replacing the storage capacitor.

### Solution to Problem

An electrophoretic display apparatus of the present invention is provided with a pair of substrates, at least one of which has optical transparency, a plurality of pixel electrodes arranged on a substrate surface of the one substrate in a matrix form, a common electrode disposed on a substrate surface of the other substrate opposite to the plurality of pixel electrodes, a liquid body sealed in between the substrates in which one or two or more kinds of electrophoretic particles are dispersed, a plurality of data lines to which the pixel electrodes are connected in row units to supply pixel signals respectively, a plurality of switches provided between the respective pixel electrodes and the data lines connected to the respective pixel electrodes, a plurality of scan lines to which the switches are connected in column units and to which pulsed scanning signals for turning on the switches are supplied so that pixel signals are applied to the pixel electrodes, a plurality of storage capacitors that can store, when a period during which no scan line is selected is assumed to be a pause period and a time required to scan all scan lines without providing any pause period is assumed to be a reference frame period, charge enough to continuously move electrophoretic particles even after a drive voltage generated between electrodes by one selection is turned off in a direction corresponding to the drive voltage for a period longer than the reference frame period, the storage capacitors being connected in parallel between the respective pixel electrodes and the common electrode respectively, and a drive circuit that outputs to the scan lines, scanning signals provided with pause periods in scan line units or group units made up of a plurality of scan lines.

With this configuration, scanning signals provided with a pause period in scan line units or group units made up of a plurality of scan lines are outputted to the scan lines under a condition that electrophoretic particles are continuously moved for a period longer than the reference frame period in a direction corresponding to the drive voltage even after the drive voltage generated between the electrodes by one selection of the storage capacitors is turned off, and therefore a pause period is inserted after a scan line is selected first and then selected next time, and it is thereby possible to make full use of energy stored in the storage capacitor. Moreover, it is possible to adjust display performance according to the length of the pause period, and thereby prevent variations of display performance and easily adjust the display without replacing the storage capacitors.

In the electrophoretic display apparatus, the drive circuit collectively provides a pause period after scanning all scan lines as one group for one frame and sets a scanning interval of the scan line unit with the collective pause period taken into consideration to be shorter than a time within which the storage capacitors can move electrophoretic particles even after the drive voltage is turned off. Thus, since the pause periods are collectively provided after scanning for one frame, the drive method is simple and a drive pattern of an existing scanning signal can be used.

In the above-described electrophoretic display apparatus, the drive circuit divides scan lines into groups of a number of scan lines smaller than the total number of scan lines, provides a pause period after selecting a final scan line of each group so that a scanning interval of the scan line unit with the collective pause period taken into consideration is set to be shorter than a time within which the storage capacitors can move electrophoretic particles even after the drive voltage is turned off. Thus, a pause period is provided after each group is selected, and therefore pause periods can be set in group units.

In the above-described electrophoretic display apparatus, the drive circuit provides a pause period for each scan line, and sets a scanning interval of the scan line unit with all the collective pause periods taken into consideration to be shorter than a time within which the storage capacitors can move electrophoretic particles even after the drive voltage is turned off. Thus, since a pause period is provided for each scan line, a pause period can be set in scan line units.

In the above-described electrophoretic display apparatus, the pause period may be configured to be changeable. Thus, the pause period can be made changeable with respect to an environment change or change over the years of the display panel, and the display can thereby be adjusted.

A drive method for an electrophoretic display apparatus of the present invention is a drive method for an electrophoretic display apparatus provided with a pair of substrates, at least one of which has optical transparency, a plurality of pixel electrodes arranged on a substrate surface of the one substrate in a matrix form, a common electrode disposed on a substrate surface of the other substrate opposite to the plurality of pixel electrodes, a liquid body sealed in between the substrates in which one or two or more kinds of electrophoretic particles are dispersed, a plurality of data lines to which the pixel electrodes are connected in row units to supply pixel signals respectively, a plurality of switches provided between the respective pixel electrodes and the data lines connected to the respective pixel electrodes, a plurality of scan lines to which the switches are connected in column units and to which pulsed scanning signals for turning on the switches are supplied so that pixel signals are applied to the pixel electrodes, a plurality of storage capacitors connected in parallel between the respective pixel electrode and the common electrode respectively, and a drive circuit that outputs a scanning signal to the scan line, wherein the storage capacitors can store, when a period during which no drive voltage is applied to any scan line is assumed to be a pause period and a time required to scan all scan lines without providing any pause period is assumed to be a reference frame period, charge enough to continuously move electrophoretic particles even after a drive voltage is turned off by one selection in a direction corresponding to the drive voltage for a period longer than the reference frame period, provide pause periods in scan line units or group units made up of a plurality of continuous scan lines and sets a pause period so that the scan interval of each scan line becomes shorter than the time during which the storage capacitors can move electrophoretic particles even after the drive voltage is turned off.

### Technical Advantage of the Invention

According to the present invention, it is possible to provide an electrophoretic display apparatus and a drive method thereof capable of making full use of energy stored in storage capacitors connected in parallel to display pixels, preventing variations of display performance and easily adjusting the display without replacing the storage capacitors.

### BRIEF DESCRIPTION OF DRAWINGS

FIG. 1 is an overall configuration diagram of an electrophoretic display apparatus according to the present embodiment;

FIG. 2 is a diagram illustrating a scanning pattern of the present embodiment;

FIG. 3 is a diagram illustrating another scanning pattern of the present embodiment;

FIG. 4 is a circuit diagram illustrating an electrical configuration of pixels in the electrophoretic display apparatus;

FIG. 5 is a partial cross-sectional view of a display section in the electrophoretic display apparatus;

FIG. 6 is a diagram illustrating an adjustable energy amount;

FIG. 7 is a characteristic diagram for verifying display performance of ink A and a characteristic diagram for verifying display performance of ink B; and

FIG. 8 is a diagram illustrating a reflection factor measurement result according to the presence/absence of a pause period.

### DESCRIPTION OF EMBODIMENTS

Hereinafter, embodiments of the present invention will be described in detail with reference to the accompanying drawings.

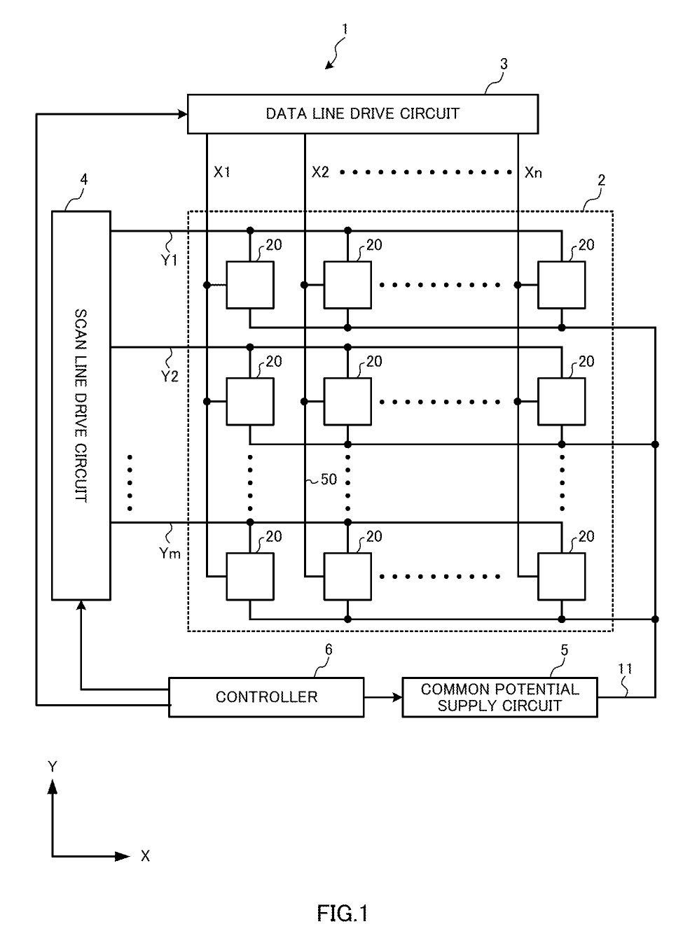

FIG. 1 is an overall configuration diagram of an electrophoretic display apparatus according to an embodiment of the present invention. This electrophoretic display apparatus 1 is configured by including a display section 2 in which display pixels are arranged in a matrix form, a data line drive circuit 3 that supplies pixel signals to the display section 2, a scan line drive circuit 4 that supplies scanning signals of a fixed pulse width to the display section 2, a common potential supply circuit 5 that gives a common potential to each display pixel of the display section 2, and a controller 6 that controls operation of the entire apparatus. The scan line drive circuit 4 outputs scanning signals so as to form a scanning pattern in which a pause period is inserted.

In the display section 2, n data lines X1 to Xn extend from the data line drive circuit 3 in a column direction (Y direction) and m scan lines Y1 to Ym crossing these data lines extend from the scan line drive circuit 4 in a row direction (X direction). In the display section 2, a display pixel 20 is formed at each intersection at which each data line (X1, X2, . . . Xn) and each scan line (Y1, Y2, . . . Ym) cross each other. In this way, in the display section 2, a plurality of the display pixels 20 are arranged in the form of a matrix with n rows and m columns.

The data line drive circuit 3 supplies a pixel signal to each data line (X1, X2, . . . Xn) based on a timing signal supplied from the controller 6. The pixel signal takes on a potential of a high potential VH (e.g., 30 V) or a low potential VL (e.g., 0 V).

The scan line drive circuit 4 sequentially supplies scanning signals of a fixed pulse width to the respective scan lines (Y1, Y2, . . . Ym) based on timing signals supplied from the controller 6.

In this way, scanning signals are supplied to the display pixels 20 to be driven. Since pixels subject to gradation control are selected by scanning signals, the scanning signals can also be called “selection signals.”

Here, a scanning pattern of a scanning signal outputted from the scan line drive circuit 4 will be described.

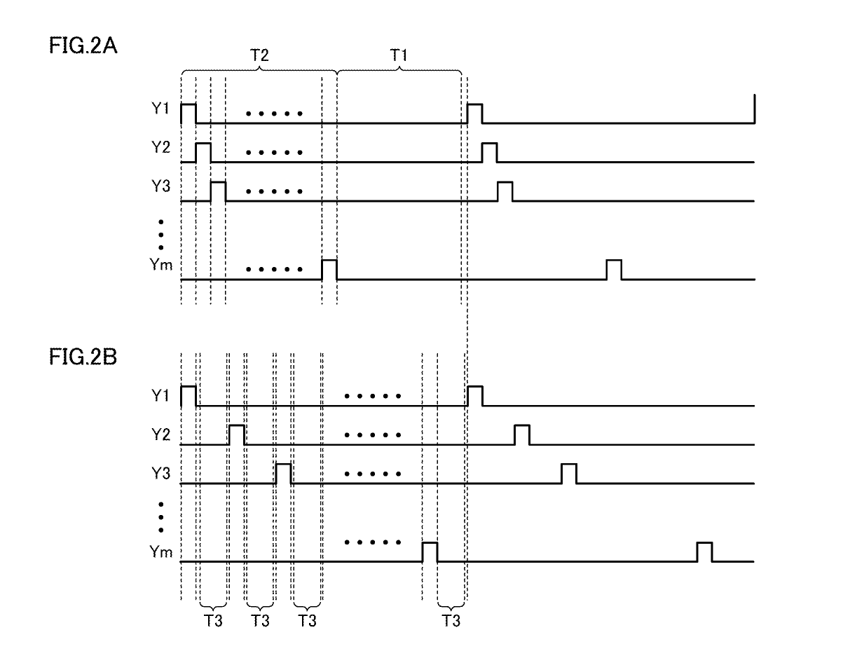

FIG. 2A illustrates a scanning pattern in which a pause period is inserted in frame units. In the scanning pattern shown in FIG. 2A, scanning signals of a fixed pulse width are sequentially selected in order of scan lines Y1, Y2, Y3 . . . Ym and a pause period T1 is inserted collectively after 1-frame scanning is completed. After the collective pause period T1, 1-frame scanning (selection of scan lines Y1, Y2, Y3 . . . Ym) is executed again. Such scanning is repeated a predetermined number of times. As with the frame scanning shown in FIG. 2A, a time required to sequentially select scan lines Y1, Y2, Y3 . . . Ym corresponding to one screen using scanning signals of a fixed pulse width without any gap between scan lines will be called a “reference frame period T2.”

FIG. 2B illustrates a scanning pattern in which a pause period is inserted in scan line units. In the scanning pattern shown in FIG. 2B, after a lapse of a pause period T3 after selecting a preceding scan line Yn, the next scan line Y(n+1) is selected. That is, the pause period T3 is inserted in each scan line. Each pause period T3 is set to an identical time width.

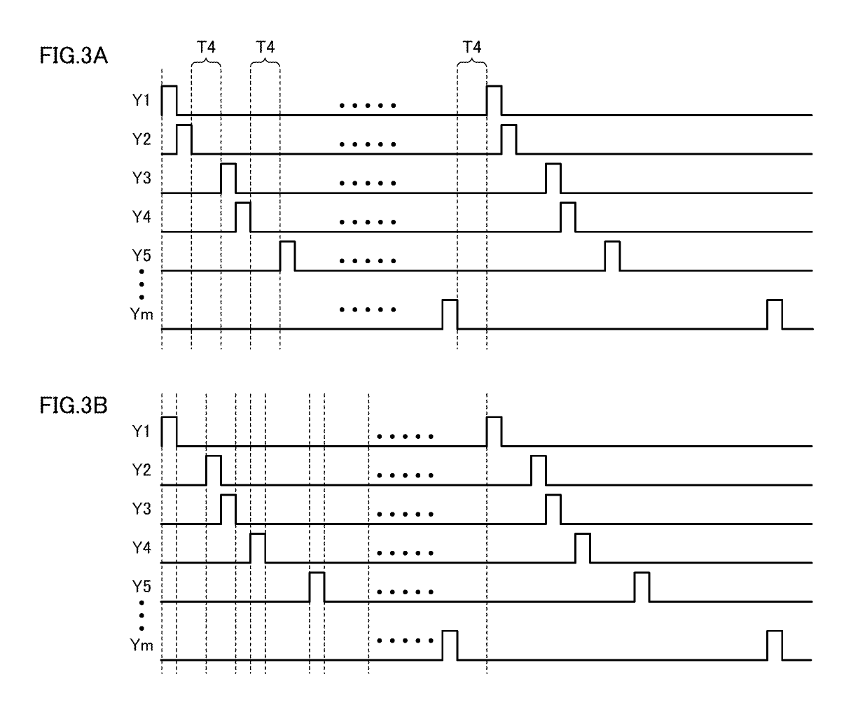

FIG. 3A illustrates a scanning pattern in which a pause period is inserted in scan line group units. In the scanning pattern shown in FIG. 3A, all scan lines Y1, Y2, Y3 . . . Ym that correspond to 1 frame are divided into a plurality of groups, each group being made up of two scan lines, no pause period is provided within each group and after the last scan line of each group is selected, a pause period T4 is inserted before selecting scan lines of the next group. Each pause period T4 is set to an identical time width. Note that if all scan lines Y1, Y2, Y3 . . . Ym that correspond to 1 frame are handled as one group, the scanning pattern would be identical to that shown in FIG. 2A.

FIG. 3B illustrates a scanning pattern in which timing of inserting a pause period and a time width of the pause period are randomized. As shown in FIG. 3B, the pause period insertion timing and the pause period time width may be set randomly.

It is possible to set beforehand, a scanning pattern with a pause time taken into consideration in the scan line drive circuit 4 which is a driver IC and configure the scan line drive circuit 4 to control pause times according to a command from the controller 6. Alternatively, command timing of the controller 6 may be controlled so as to control command output timing from the scan line drive circuit 4.

The selection of the above-described pattern and the determination of command output timing may also be changed according to the values of determination parameters such as accumulated application count, accumulated application time, elapsed time from manufacturing and product operating ambient temperature. These determination parameters, necessary memory, program, sensor or the like are mounted in the product as appropriate.

A common potential Vcom is applied to each display pixel 20 making up the display section 2 from the common potential supply circuit 5 via the common potential line 11. The common potential Vcom is a high potential VH (e.g., 40 V) or a low potential VL (e.g., 0 V).

The controller 6 supplies timing signals such as a clock signal and a start pulse to the data line drive circuit 3, scan line drive circuit 4 and common potential supply circuit 5, and controls each circuit. The controller 6 supplies gradation data of a display target pixel to the data line drive circuit 3 or common potential supply circuit 5. The data line drive circuit 3 or common potential supply circuit 5 determines an application count and a voltage value of a write pulse according to the gradation data and supplies a pixel signal or common potential to a target pixel in synchronization with a frame scanning (pixel row selection) operation of the scan line drive circuit 4.

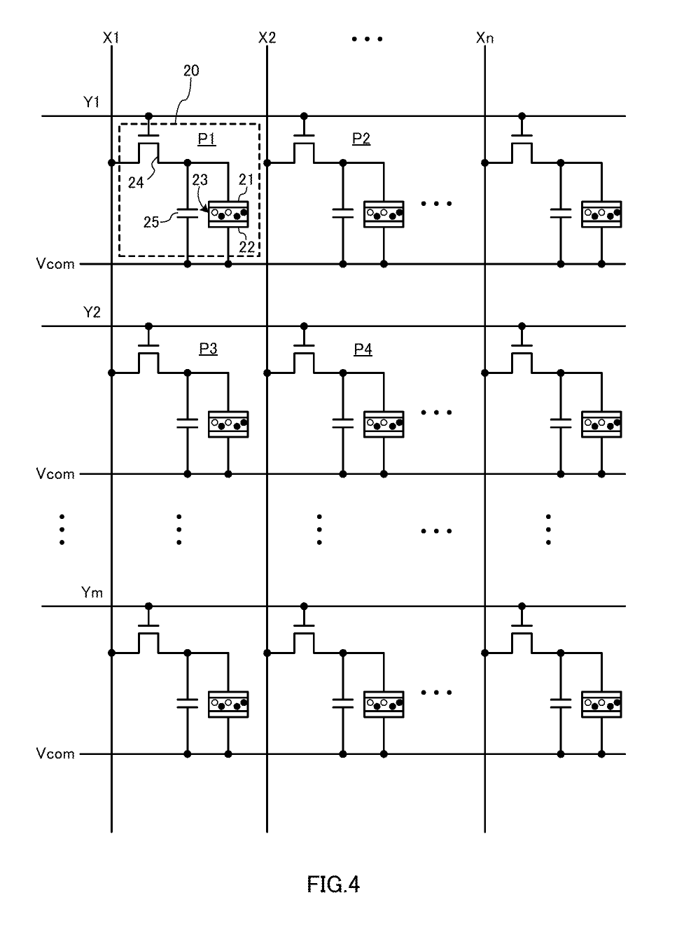

FIG. 4 is a circuit diagram illustrating an electrical configuration of the display pixel 20. Since the respective display pixels 20 arranged in the display section 2 in a matrix form have an identical configuration, components making up the display pixels 20 are assigned common reference numerals and description thereof will be omitted.

The display pixel 20 is provided with a pixel electrode 21, a common electrode 22, an electrophoretic element 23, a pixel switching transistor 24 and a storage capacitor 25. The pixel switching transistor 24 can be made up of, for example, a TFT (Thin Film Transistor). A gate of the pixel switching transistor 24 is electrically connected to a scan line (Y1, Y2, . . . Ym) of a corresponding row. A source of the pixel switching transistor 24 is electrically connected to a data line (X1, X2, . . . Xn) of a corresponding column. Furthermore, a drain of the pixel switching transistor 24 is electrically connected to the pixel electrode 21 and the storage capacitor 25. The pixel switching transistor 24 outputs a pixel signal supplied from the data line drive circuit 3 via a data line (X1, X2, . . . Xn) to the pixel electrode 21 and the storage capacitor 25 at timing corresponding to a pulsed scanning signal supplied from the scan line drive circuit 4 via a scan line (Y1, Y2, . . . Ym) of the corresponding row.

A pixel signal is supplied to the pixel electrode 21 from the data line drive circuit 3 via the data line (X1, X2, . . . Xn) and the pixel switching transistor 24. The pixel electrode 21 is disposed opposite to the common electrode 22 via the electrophoretic element 23. The common electrode 22 is electrically connected to the common potential line 11 to which a common potential Vcom is supplied.

The electrophoretic element 23 is a liquid containing electrophoretic particles of at least one kind and is sealed using a sealer (not shown) between the electrodes so as not to leak.

The storage capacitor 25 is made up of a pair of electrodes arranged opposite to each other across a dielectric film, one electrode is electrically connected to the pixel electrode 21 and pixel switching transistor 24 and the other electrode is electrically connected to the common potential line 11. The storage capacitor 25 has a capacitance enough to store charge to continuously move electrophoretic particles in a direction corresponding to the drive voltage for a time longer than the reference frame period T2 even after a drive voltage generated between the electrodes of the display pixel 20 by one selection is turned off.

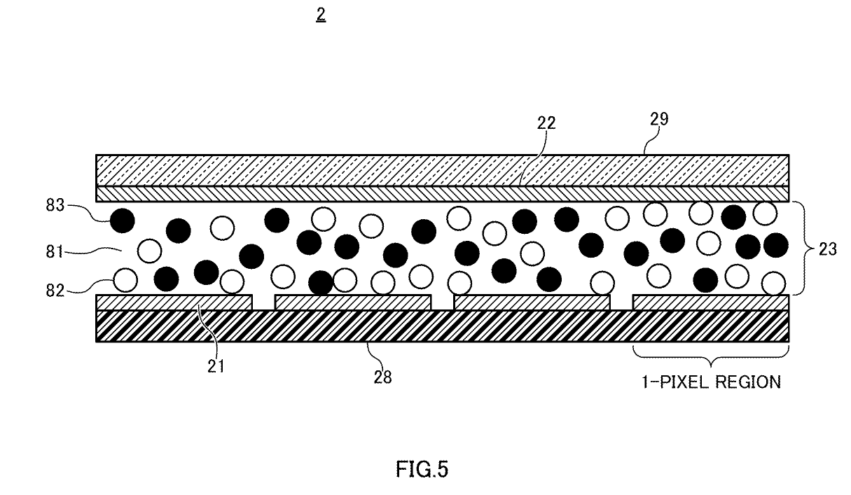

Next, a specific configuration of the display section 2 of the electrophoretic display apparatus 1 will be described based on FIG. 5. FIG. 5 is a partial cross-sectional view of the display section 2 of the electrophoretic display apparatus 1. The display section 2 is constructed of an element substrate 28 and an opposite substrate 29 arranged opposite to each other via a spacer (not shown) with an electrophoretic element 23 sealed in between the substrates. The present embodiment will be described based on the premise that an image is displayed on the opposite substrate 29 side.

The element substrate 28 is a substrate made of glass or plastic or the like. Though not shown here, a laminated structure is formed on the element substrate 28, which includes the pixel switching transistor 24, the storage capacitor 25, the scan lines (Y1, Y2, . . . Ym), the data lines (X1, X2, . . . Xn), the common potential line 11 or the like described above with reference to FIG. 4. A plurality of pixel electrodes 21 are provided on the upper layer side of this laminated structure in a matrix form.

The opposite substrate 29 is, for example, an optical transparent substrate made of glass, plastic or the like. The common electrode 22 is formed opposite to the plurality of pixel electrodes 21 on the opposite surface of the element substrate 28 in the opposite substrate 29. The common electrode 22 is formed of a transparent conductive material such as magnesium silver (MgAg), indium tin oxide (ITO), indium zinc oxide (IZO).

In the present embodiment, the electrophoretic element 23 is an electrophoretic display liquid made up of positively charged black particles 83, negatively charged white particles 82 and a dispersion medium 81 that disperses these black particles 83 and white particles 82, and all these elements are sealed in between the element substrate 28 and the opposite substrate 29. A spacer (not shown) for keeping the distance between the substrates to a defined value is provided between the element substrate 28 and the opposite substrate 29, and a sealer (not shown) for sealing the gap is provided at an end face of the substrate.

When a voltage is applied between the pixel electrode 21 and the common electrode 22 so that the potential of the common electrode 22 becomes relatively higher, the positively charged black particles 83 are attracted to the pixel electrode 21 side by a Coulomb force and the negatively charged white particles 82 are attracted to the common electrode 22 side by the Coulomb force. As a result, the white particles 82 are concentrated on the display surface side (common electrode 22 side) and the display surface of the display section 2 becomes white display. On the other hand, when a voltage is applied between the pixel electrode 21 and the common electrode 22 so that the potential of the pixel electrode 21 becomes relatively higher (the potential of the common electrode 22 becomes relatively lower), the positively charged black particles 83 are attracted to the common electrode 22 side by the Coulomb force and the negatively charged white particles 82 are attracted to the pixel electrode 21 side by the Coulomb force. As a result, the black particles 83 are concentrated on the display surface side (common electrode 22 side) and the display surface of the display section 2 becomes black display.

By changing pigments used for the white particles 82 and the black particles 83 to, for example, pigments of red, green or blue colors, it is possible to change the display surface of the display section 2 to a red display, green display or blue display or the like.

When particles are placed under an identical electric field, the moving speed differs between the white and black particles depending on the particle size or other factors. The present embodiment will describe a case where white particles move faster than black particles.

Next, drive operation in the electrophoretic display apparatus 1 configured as described above will be described. The data line drive circuit 3 applies pixel signals to data lines X to which the target display pixels 20 are connected and the scan line drive circuit 4 supplies scanning signals to scan lines Y according to a scanning pattern in which a pause period is inserted. For example, in the case of the scanning pattern shown in FIG. 2A, scanning signals of a fixed pulse width are sequentially selected in order of scan lines Y1, Y2, Y3 . . . Ym without a break and the pause period T1 is collectively inserted after completing 1-frame scanning. The scanning with the pause period T1 is collectively inserted in the frame units shown in FIG. 2A is repeated until target pixels become required gradation.

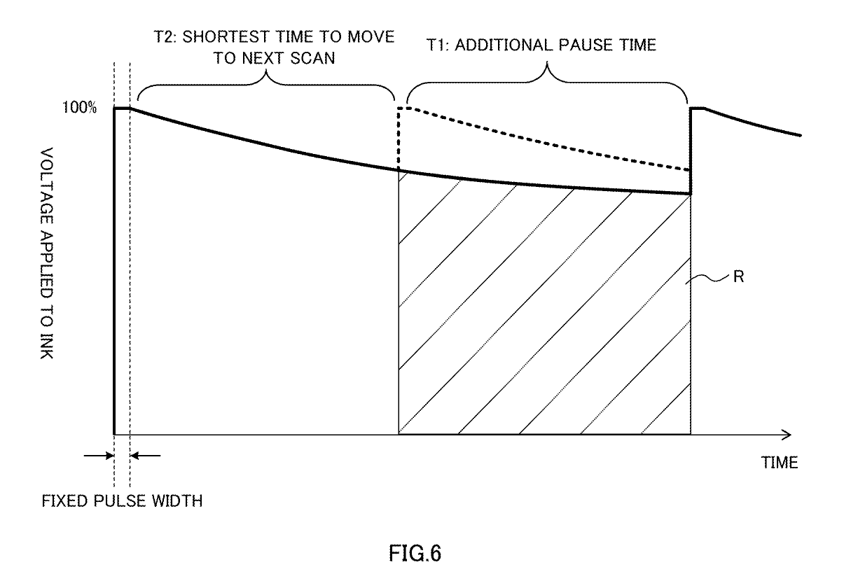

FIG. 6 is a diagram illustrating a time variation of a drive voltage applied to the electrophoretic element 23.

For example, a case will be considered where the electrophoretic element 23 is provided with a storage capacitor 25 with a capacitance suitable for a panel including Ym×2 scan lines in one frame. Suppose the storage capacitor 25 has a capacitance enough to move the electrophoretic element 23 for a time Tm required to select all scan lines (Ym×2) in the drive voltage direction. That is, if a standard frame period is Tm, the storage capacitor 25 has a capacitance that allows the stored energy to be efficiently used. However, when applied to a panel with Ym corresponding to half the number of scan lines, the next scanning is started before the drive voltage drops sufficiently as shown by a dotted line in FIG. 6, that is, at a stage at which sufficient energy still remains. Thus, the present embodiment inserts an additional pause period T1 so that it is not until the drive voltage of the storage capacitor 25 is extended to close to a lower limit within which electrophoretic particles can be moved that the next scanning starts. Therefore, by inserting the pause period T1, it is possible to effectively use energy of a region R shown by the shaded area in FIG. 6.

When it is predicted due to a change in the environment temperature or deterioration over the years that the initial display performance may not be kept if the pause period T1 remains unchanged, the display performance can be improved by shortening the pause period T1. That is, the display performance can be improved without any operation such as replacement of the storage capacitor 25.

Here, a verification result relating to a pause period inserted in a scanning pattern will be described.

There are a variety of inks used for the electrophoretic element 23, and ink A which is a kind of ink having a large discharge time constant and ink B which is a kind of ink having a small discharge time constant were used for verification. Ink A has a volume resistivity of 4.9E10 (Ωcm), a dielectric constant of 3.2, a discharge time constant of 13.9 ms, and a discharge time constant including the storage capacitor 25 of 60.8 ms. Ink B has a volume resistivity of 2.6E10 (Ωcm), a dielectric constant of 4.3, a discharge time constant of 9.9 ms, and a discharge time constant including the storage capacitor 25 of 34.8 ms.

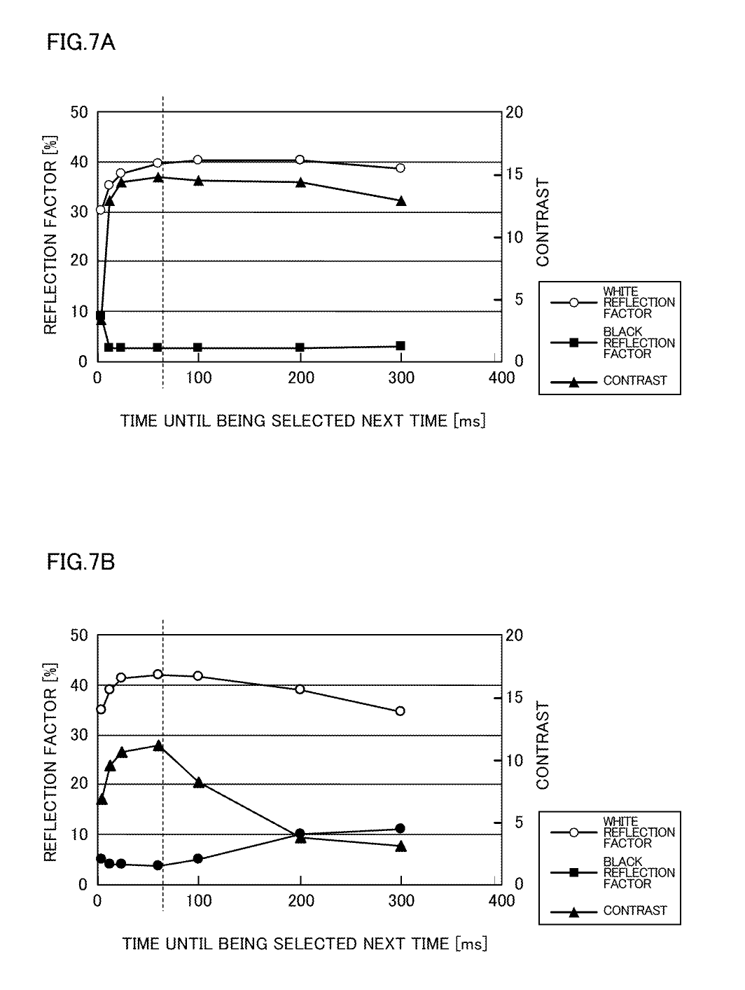

For inks A and B, an experiment was conducted in which a frame scan applying a drive voltage for 20 μs was performed 120 times. 20 μs is a time corresponding to a pulse width of a fixed pulse. Measurements were made on a change in a reflection factor of display pixels and a change in contrast when an elapsed time (corresponding to a pause period) until the next one was selected was changed in 1-frame scan. The results are shown in FIGS. 7A and 7B. FIG. 7A shows the measure result relating to ink A and FIG. 7B shows the measure result relating to ink B. As shown in FIG. 7A, with ink A, the contrast decreases after around 60.8 ms which is a discharge time constant including the storage capacitor 25. However, since the reflection factor gently decreases even beyond the discharge time constant, there is a high possibility that the display performance required to reach 1.6 to 2.3 times the discharge time constant including the storage capacitor 25 may be secured. As shown in FIG. 7B, with ink B, the display performance reaches a peak around 34.8 ms which is a discharge time constant including the storage capacitor 25. However, even after surpassing the discharge time constant, since the display performance is maintained up to around 60 ms, there is a high possibility that the display performance required to reach 1.6 to 2.3 times the discharge time constant including the storage capacitor 25 may be secured. Note that when the display performance is seen from the viewpoint of a remaining voltage of the drive voltage, the voltage at which the remaining voltage becomes 36.8% of the applied voltage is a time constant itself, and the voltage at which the remaining voltage becomes 20% of the applied voltage is 1.6 times the time constant, and the voltage at which the remaining voltage becomes 10% of the applied voltage is 2.3 times the time constant. Based on the above-described verification results, it is clear that when the pause period is 2.3 times the time constant or less, certain display performance can be realized, and the pause period is preferably 1.6 times the time constant or less or most preferably close to the time constant.

Hereinafter, test results regarding the display performance using a test pixel will be described. A test pixel was created for testing a reflection factor which is one of display performance factors. A test pixel was created by sealing an electrophoretic liquid (ink A) in between an element substrate made of raw material of ITO-PET, having a size of 30 mm on all four sides, and an opposite substrate with an adhesive so that the distance between the electrodes (pixel electrode−common electrode) would be 20 μm. The potential difference between the common electrode and the data line was ±15 V, and the width of a fixed pulse supplied to a drive corresponding to one scan line Y1 was 20 μs. Here, suppose a panel whose total number of scan lines is 192. A time (standard frame period Tm) required for 1-frame scanning by sequentially supplying scanning signals having a pulse width of 20 μs to all scan lines Y1 to Y192 without a break is 3.84 ms. When a scanning pattern is applied in which the pause period T1 is collectively inserted after 1-frame scan, if attention is focused on one display pixel 20, an interval after the display pixel 20 is selected last time until it is selected next time is standard frame period Tm (=3.84 ms)+pause period T1. If a case is assumed where frame scanning is performed 120 times by applying a scanning pattern of collectively inserting the pause period T1, a potential difference (±15 V) is repeatedly applied to the one focused display pixel 20 at an interval of standard frame period Tm (=3.84 ms)+pause period T1.

Thus, a reflection factor was measured after repeatedly applying the potential difference (±15 V) to the test pixel at an interval of standard frame period Tm (=3.84 ms)+pause period T1. Measurements were conducted on four patterns of pause period T1 of 0, 2.56 ms, 8.16 ms and 20.16 ms with the storage capacitor Cs to be inserted fixed to 3.3 nF. A spectrophotometer manufactured by Suga Test Instruments Co., Ltd. was used to measure the reflection factor.

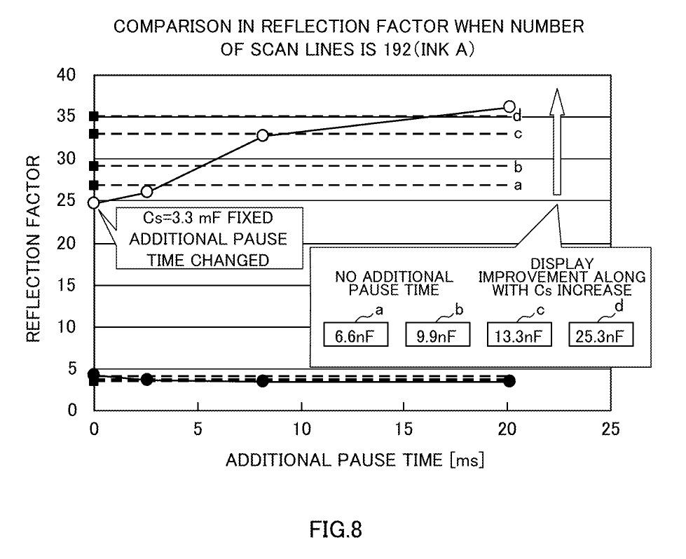

A reflection factor was measured using the above-described test pixel when the storage capacitor Cs to be inserted was changed without adding any pause time T1 from 3.3 nF (=3.67 [pF/mm2]) to 25.3 nF (=28.1 [pF/mm2]) (a, b, c, d in FIG. 8). FIG. 8 shows these two measurement results. As shown in FIG. 8, although the display performance increases as the storage capacitor Cs increases, it is seen that the display performance in the case where an additional pause time of 20.16 ms is provided is better. As described above, it is seen that insertion of the pause time T1 into a scanning pattern improves display performance of the test pixel. From above, it is possible to improve display performance as the display section 20 by repeating scanning by applying a scanning pattern in which a pause period is inserted for the display section 2 in which the display pixels 20 are arranged in a matrix form.

Using the same test pixel as that described above, a reflection factor in a case where no additional pause time was provided (T1=0) was compared with that in a case where an additional pause time of 8.61 ms was inserted using six kinds of electrophoretic liquids by fixing the storage capacitor Cs to 6.6 nF, setting a potential difference between electrodes during a selection (pixel electrode—common electrode) to ±15 V, setting the fixed pulse width of a scanning signal to 20 μs, setting an interval corresponding to 192 scan lines and an application constant corresponding to a scan count of 120. As a result, the display performance improved for all the six kinds of ink when an additional pause time was provided. Although these six kinds of ink differ in a black/white particle compound ratio, particle surface treatment and dispersion medium, there is no difference in that these are two-particle-based electrophoretic inks in which two types of positively and negatively charged particles exist in the dispersion medium. From this, it is seen that the present invention also produces effects with inks having different black/white particle ratios and dispersion media.

The present invention is not limited to the above-described embodiment, but can be implemented modified in various ways. Sizes and shapes illustrated in the accompanying drawings are not limited to those in the above-described embodiment, but can be changed as appropriate within a scope in which the effects of the present invention can be produced. Other aspects of the present invention can be changed as appropriate without departing from the scope of the object of the present invention.

The present application is based on Japanese Patent Application No. 2012-238958 filed on Oct. 30, 2012, entire content of which is expressly incorporated by reference herein.

1. An electrophoretic display apparatus comprising:
a pair of substrates at least one of which has optical transparency;
a plurality of pixel electrodes arranged on a substrate surface of the one substrate in a matrix form;
a common electrode disposed on a substrate surface of the other substrate opposite to the plurality of pixel electrodes;
a liquid body sealed in between the substrates in which one or two or more kinds of electrophoretic particles are dispersed;
a plurality of data lines to which the pixel electrodes are connected in row units to supply pixel signals respectively;
a plurality of switches provided between the respective pixel electrodes and the data lines connected to the respective pixel electrodes;
a plurality of scan lines to which the switches are connected in column units and to which pulsed scanning signals for turning on the switches are supplied respectively so that pixel signals are applied to the pixel electrodes;
a plurality of storage capacitors that can store, when a period during which no scan line is selected is assumed to be a pause period and a time required to scan all scan lines without providing any pause period is assumed to be a reference frame period, charge enough to continuously move electrophoretic particles even after a drive voltage generated between electrodes by one selection is turned off in a direction corresponding to the drive voltage for a period longer than the reference frame period, the storage capacitors being connected in parallel between the respective pixel electrodes and the common electrode respectively; and
a drive circuit that outputs to the scan lines, scanning signals to which a pause period is added in scan line units or group units made up of a plurality of scan lines.

2. The electrophoretic display apparatus according to claim 1, wherein the drive circuit collectively adds a pause period after scanning all scan lines as one group for one frame and a scanning interval of the scan line unit with the collective pause period taken into consideration is shorter than a time within which the storage capacitor can move electrophoretic particles even after the drive voltage is turned off.

3. The electrophoretic display apparatus according to claim 1, wherein the drive circuit divides scan lines into groups of a number of scan lines smaller than the total number of scan lines, adds a pause period after selecting a final scan line of each group so that a scanning interval in the scan line unit with the pause periods of all the groups taken into consideration is shorter than a time within which the storage capacitor can move electrophoretic particles even after the drive voltage is turned off.

4. The electrophoretic display apparatus according to claim 1, wherein the drive circuit adds a pause period for each scan line, and a scanning interval in the scan line unit with all the collective pause periods taken into consideration is shorter than a time within which the storage capacitor can move electrophoretic particles even after the drive voltage is turned off.

5. The electrophoretic display apparatus according to claim 1, wherein the pause period is configured to be changeable.

6. A method for driving an electrophoretic display apparatus, comprising:
a pair of substrates at least one of which has optical transparency;
a plurality of pixel electrodes arranged on a substrate surface of the one substrate in a matrix form;
a common electrode disposed on a substrate surface of the other substrate opposite to the plurality of pixel electrodes;
a liquid body sealed in between the substrates in which one or two or more kinds of electrophoretic particles are dispersed;
a plurality of data lines to which the pixel electrodes are connected in row units to supply pixel signals respectively;
a plurality of switches provided between the respective pixel electrodes and the data lines connected to the respective pixel electrodes;
a plurality of scan lines to which the switches are connected in column units and to which pulsed scanning signals for turning on the switches are supplied respectively so that pixel signals are applied to the pixel electrodes;
a plurality of storage capacitors connected in parallel between the respective pixel electrode and the common electrode respectively; and
a drive circuit that outputs a scanning signal to the scan line,
wherein assuming a period during which no scan line is selected to be a pause period and a time required to scan all scan lines without providing any pause period to be a reference frame period, the storage capacitors can store charge enough to continuously move electrophoretic particles even after a drive voltage by one selection is turned off in a direction corresponding to the drive voltage for a period longer than the reference frame period, adds pause periods in scan line units or group units made up of a plurality of scan lines and adds a pause period so that the scan interval of each scan line is shorter than the time during which the storage capacitors can move electrophoretic particles even after the drive voltage is turned off.

7. The electrophoretic display apparatus according to claim 2, wherein the pause period is configured to be changeable.

8. The electrophoretic display apparatus according to claim 3, wherein the pause period is configured to be changeable.

9. The electrophoretic display apparatus according to claim 4, wherein the pause period is configured to be changeable.
